(19) United States
(12) Patent Application Publication
(10) Pub. No.: US 2021/0188543 A1
(43) Pub. Date: Jun. 24, 2021

(54) EDGE PROCESSING SYSTEM

(71) Applicant: IMA Schelling Deutschland GmbH, Lübbecke (DE)

(72) Inventors: Thomas Hampel, Lübbecke (DE); Stefan Hüsener, Hille (DE); Tim Kottkamp, Lübbecke (DE); Uwe Seifert, Preussisch Oldendorf (DE)

(73) Assignee: IMA Schelling Deutschland GmbH, Lübbecke (DE)

(21) Appl. No.: 16/755,587

(22) PCT Filed: Nov. 2, 2018
(86) PCT No.: PCT/EP2018/079969

§ 371 Date: Apr. 12, 2020

(30) Foreign Application Priority Data
Nov. 7, 2017 (DE) 10 2017 125 936.8

(51) Int. Cl. B65G 1/04; B27D 5/00

(52) U.S. Cl. CPC B65G 1/04; B27D 5/003

(57) ABSTRACT

An edge processing system has at least one edge processing machine to which an edge magazine is attached and at least one primary cassette reserve arranged in the spatial vicinity of the edge magazine of the edge processing machine. The primary cassette reserve has a plurality of receptacle slots in which cassettes can be or are received, each containing an edge band. The edge processing system further comprises at least one secondary cassette reserve, which is different from the primary cassette reserve and which is arranged spatially separate from the primary cassette reserve.

### CROSS REFERENCE TO RELATED APPLICATIONS

This patent application is the US National Phase of and claims priority on and the benefit of International Application No. PCT/EP2018/079969 having an international filing date of 2 Nov. 2018, which claims priority on and the benefit of German Patent Application No. 10 2017 125 936.8 having a filing date of 7 Nov. 2017.

### BACKGROUND OF THE INVENTION

### Technical Field

The invention relates to an edge processing system having at least one edge processing machine to which an edge magazine is attached and at least one primary cassette reserve arranged in the spatial vicinity to the edge magazine of the edge processing machine and which has a plurality of receptacle slots in which cassettes can be or are received, each containing an edge band.

### Prior Art

Edge processing machines provide panels made of wood and wood materials machines with a wide variety of edge bands (hereinafter also referred to as “edges”) on their narrow sides. The edge bands have a wide variety of widths, colors, decors and thicknesses and consist of different materials. A large number of different edge bands must therefore be kept in stock during production. For this purpose, the edge bands to be processed, which come from rolls, are fed to the edge magazine of the edge processing machine. The rolls are provided in appropriate supply devices such as roller magazines and arranged in the vicinity of the edge magazines. A machine operator who has loaded the roll magazines accordingly advances the free ends of the edge band to the edge magazine from where it is then automatically fed to the edge processing machine in accordance with the production step specified by the machine control.

The size of a roll magazine depends on the processing speed of the edge processing machine, the order sizes and the capacity of the operator.

In order to simplify the handling of the edges, it has been proposed to provide the edge band in edge cassettes instead of on rolls as disclosed, for example, in EP 1 862 949 B1. The uniform dimensions can simplify the handling of the edges. If there is a cassette reserve in front of an edge magazine, the storage spaces are uniform. DE 10 2009 010 792 A1 discloses a multi-axis robot that takes over the loading of the edge magazine from the cassette reserve, which makes the loading process faster and safer.

A similar device is described in EP 2 505 322 B1 in which the edge band feed is also carried out automatically, but without a multi-axis robot. The system is designed so that the edge magazine can be loaded from two magazines.

In the solutions described, the capacity of the roll or cassette reserves is limited, so the removal of empty rolls or cassettes as well as the loading of the magazines must be done manually.

### BRIEF SUMMARY OF THE INVENTION

The object of the invention is to keep a larger supply of edge bands in a manner that is as simple as possible in order to increase the flexibility of the edge processing systems.

The object is achieved by an edge processing system having at least one edge processing machine to which an edge magazine is attached and at least one primary cassette reserve arranged in the spatial vicinity to the edge magazine of the edge processing machine, which has a plurality of receptacle slots, in which cassettes can be or are received, each containing an edge band, characterized in that the edge processing system further comprises at least one secondary cassette reserve different from the primary cassette reserve, which is arranged spatially separate from the primary cassette reserve. Advantageous embodiments are found in the respective dependent claims.

The invention provides for an edge processing system having at least one edge processing machine to which an edge magazine is attached and at least one primary cassette reserve arranged in the spatial vicinity to the edge magazine of the edge processing machine. The primary cassette reserve has a plurality of receptacle slots in which cassettes can be or are received, each containing an edge band.

Furthermore, the edge processing system comprises at least one secondary cassette reserve, which is different from the primary cassette reserve and which is arranged spatially separate from the primary cassette reserve. This secondary cassette reserve does not have to be designed so that the edge magazine can be loaded directly from there but serves as a nearby storage space from which the primary cassette reserve can be loaded without having to travel long distances. The loading can be done quickly and therefore promptly.

In a preferred embodiment, the edge processing system comprises at least one automated manipulation device. This automated manipulation device can take on various tasks with respect to the edge processing machine, so they no longer have to be carried out manually. In a particularly preferred embodiment, the automated manipulation device, which can be designed, for example, as a robot, is configured to transfer cassettes from the primary cassette reserve to the secondary cassette reserve and/or from the secondary cassette reserve to the primary cassette reserve.

In a further preferred embodiment, the automatic manipulation device can feed an edge band, which is in a cassette located in the primary cassette reserve at a receiving location, to the edge magazine of the edge processing machine and/or pull it out of the edge magazine into the cassette. In yet another preferred embodiment, the automated manipulation device can place the cassette on a cassette transport device, in particular a cassette transport carriage, or remove it from the cassette transport device.

A separate manipulation device can be used for each of these tasks. However, it is also possible for a manipulation device to perform some of the tasks.

In a very particularly preferred embodiment, the automated manipulation device can also perform several or all of the tasks listed. Thus, the operator can be relieved on the one hand, and the loading process can be accelerated on the other.

Such an edge processing system is not limited by the fact that the secondary cassette reserve is arranged in the immediate vicinity of the primary cassette reserve. It is entirely possible to arrange a larger storage in the vicinity of the edge processing machine or to provide a secondary cassette reserve for more than one edge processing machine. In a further preferred embodiment, the at least one secondary cassette reserve is arranged on the floor adjacent to an associated edge processing machine and/or above and/or below and/or within an associated edge processing machine or is placed as an edge storage away from the edge processing machine.

Depending on the size and embodiment, it may be that one manipulation device is not sufficient, and that the secondary cassette reserve is managed by at least one further manipulator. In a particularly preferred embodiment, the secondary cassette reserve therefore comprises a reserve control device which is designed to
i) remove a cassette within the secondary cassette reserve from the storage space there; and/or
ii) deposit a cassette within the secondary cassette reserve in a storage space there; and/or
iii) transfer and/or remove a cassette to a supply or return device;
and/or the secondary cassette reserve can be loaded directly from a transport device.

In a very particularly preferred embodiment, the secondary cassette reserve has a supply or return device by means of which the cassettes transferred from the primary cassette reserve can be received by the secondary cassette reserve and/or the cassettes intended for transfer from the secondary to the primary cassette reserve can be supplied. In a further, particularly preferred embodiment, the manipulation device is designed to load cassettes directly into a reserve control device of the secondary cassette reserve and/or to remove cassettes directly from the secondary cassette reserve.

Especially with respect to frequent order changes of the edge processing machine or with larger secondary cassette devices, it is possible that the coordination between individual manipulators and/or between the manipulators and the supply or return device is not always smooth. For this purpose, it makes sense to provide the transfer with a buffer that is loaded from one side, which the other side will remove later. In a further particularly preferred embodiment of the edge processing system, the supply or return device therefore comprises a buffer for the temporary storage of cassettes outside the primary edge reserve and the secondary edge reserve, or it is connected to such.

The previously described embodiments of the invention make no statement about the supply of the at least one secondary cassette reserve. The supply can be done manually by an operator who supplies the secondary cassette reserve from the central edge storage. In a further preferred embodiment, the edge processing system comprises a central edge storage which is logistically connected via transport devices to at least one secondary cassette reserve, preferably two secondary cassette reserves, and/or at least one primary cassette reserve. It is particularly preferred here that the transport devices comprise transport means which are designed to transport cassettes in the central edge storage from the central edge storage to at least one secondary cassette reserve and/or cassettes from at least one secondary cassette reserve and/or a primary cassette reserve to the central edge storage.

The versions of the edge processing system discussed so far always pertain to cassettes in which the edge band is stored and transported to the processing machine. This manner of storing and transporting the edge band is not an exclusive type of edging handling. In a further embodiment of the edge processing system, the primary cassette reserve and/or the secondary cassette reserve and/or the central edge storage and/or the manipulation device is/are designed to receive and/or process and/or handle edge band rolls without cassettes.

### BRIEF DESCRIPTION OF THE DRAWINGS

The invention will be explained in more detail below with the help of exemplary embodiments.

FIG. 1 shows part of an edge processing system according to the invention.

FIG. 2 shows a system according to the invention with a secondary cassette reserve provided.

FIG. 3 shows an edge processing system with a secondary cassette reserve, which is arranged above the edge processing machine.

FIG. 4 shows an edge processing system in which two edge processing machines are indirectly supplied with edge strips from a central edge storage.

### DETAILED DESCRIPTION OF PREFERRED EMBODIMENTS

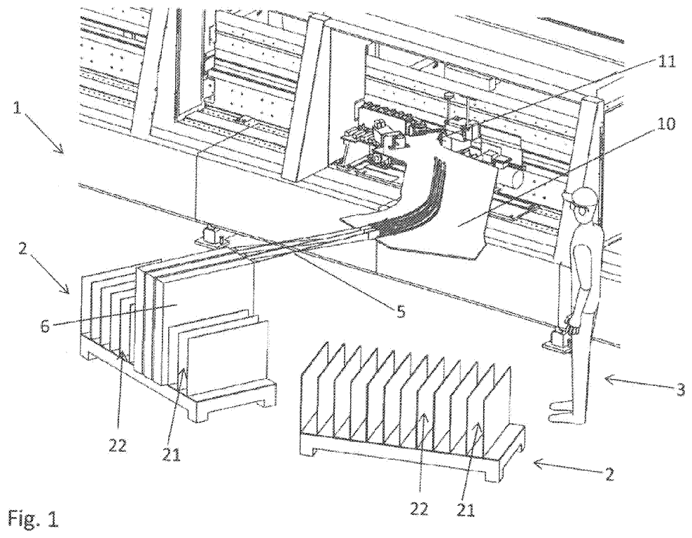

The detail in FIG. 1 shows an edge processing machine 1 in which the edge bands 5 are fed to the edge magazine 10, 11 which is part of the machine. For this purpose, the operator 3 removes the edge bands 5 from cassettes 6, which are arranged in the primary cassette reserve 2. The primary cassette reserve 2 has a number of receptacle slots 21, 22 into which the cassettes 6 are placed. In the example shown, two elements (one is conceivable as well) of a primary cassette reserve 2 are shown, which are arranged around the edge magazine 10, 11. In the system shown, the operator 3 must also, in addition to the task described above, load the primary cassette reserve 2 and remove the cassettes 6 that are no longer needed.

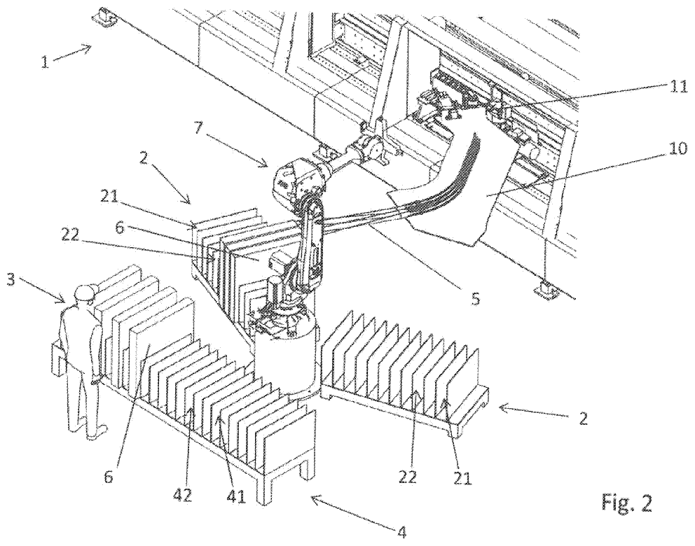

The embodiment of the edge processing system according to the invention shown in FIG. 2 was supplemented on the one hand by a manipulation device 7, which is placed within reach of the at least one element of the primary cassette reserve 2, and on the other hand by a secondary cassette reserve 4, which is arranged behind the primary cassette reserve 2 when viewed from the direction of the edge processing machine 1. The manipulation device 7 shown here takes over the tasks of feeding the edge bands 5 from the cassettes 6 stored in the primary cassette reserve 2 to the edge magazine 10, 11, loading the receptacle slots 21, 22 with cassettes 6 from the secondary cassette reserve 4 and transporting cassettes 6 that are no longer immediately required from the primary cassette reserve 2 to the storage spaces 41, 42 of the secondary cassette reserve 4. With such an edge processing system, a direct supply of the edge processing machine 1 with edge bands 5 is ensured by means of an automatic manipulation device 7. The task of the operator is to fill the secondary cassette reserve 4 with appropriate cassettes 6 or to remove cassettes 6 that are no longer needed. The secondary cassette reserve 4 shown here is highly limited by the number of storage spaces 41, 42.

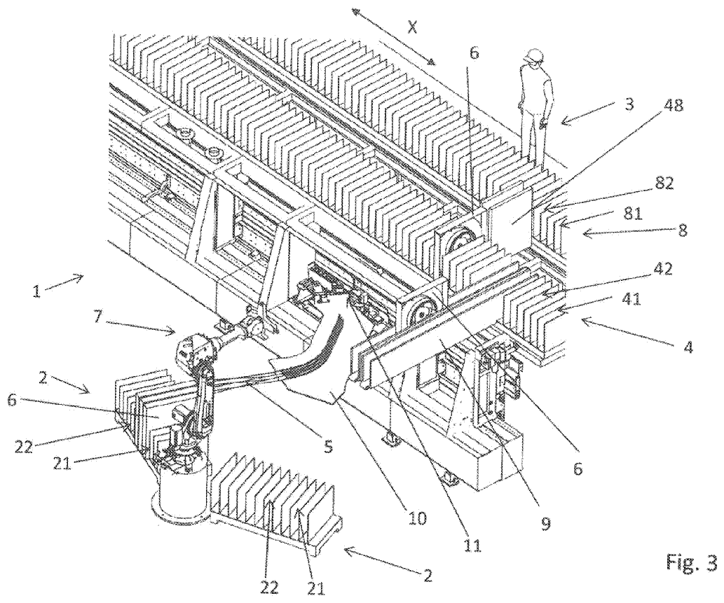

FIG. 3 shows an edge processing system with a larger secondary cassette reserve 4, 8. The secondary cassette reserve 4, 8 shown in FIG. 3 is arranged above and, viewed from the direction of the manipulation device 7, behind the edge processing machine 1. With such an arrangement, it is difficult, if not impossible, for the manipulation device 7 to directly access the cassettes 6 in the storage spaces 41, 42, 81, 82. The secondary cassette reserve 4, 8 is therefore equipped with a supply or return device 9 from which the manipulation device 7 can remove cassettes 6 and place them in the primary cassette reserve 2 or deposit cassettes 6 from the primary cassette reserve 2 that are no longer needed for storage in the secondary cassette reserve 4, 8. On the secondary cassette reserve side 4, 8, the supply or return device 9 is provided with a supply control device 48. The reserve control device 48 moves along the arrangement of the storage spaces 41, 42 and 81, 82 of the secondary cassette reserve 4, 8 in the direction X. The reserve control device 48 removes the requested cassette 6 from the corresponding storage space 41, 42, 81, 82 of the secondary cassette reserve 4, 8 and transfers it to the supply and return device 9. For the return, the reserve control device 48 removes the cassettes 6 supplied by the manipulation device 7 from the supply or return device 9 and places them on one of the storage spaces 41, 42, 81, 82 of the secondary cassette reserve 4, 8.

In the exemplary embodiment shown, the supply or return device 9 is designed such that it can accommodate a plurality of cassettes both during the supply and during the return. The supply control device 48 can thus store a plurality of cassettes 6 in the supply or return device 9 and is not dependent on the manipulation device 7 for removing the cassettes directly. At the same time, the manipulation device 7 can deposit a plurality of cassettes 6 which is to be returned to the supply or return device 9 before the reserve control device 48 supplies it to the supply or return device 9 for storage in the secondary cassette reserve 4, 8. With this buffer, which is provided by the supply or return device 9, the manipulation device 7 and the reserve control device 48 can act somewhat more independently from each other.

In this embodiment shown in FIG. 3, it is the responsibility of the operator 3 to maintain the secondary cassette reserve 4, 8 by loading cassettes 6 from the central edge storage 30 (not shown here) into the same and removing cassettes 6 that are no longer required indirectly from the secondary cassette storage 4, 8. The size of such a secondary cassette reserve 4, 8 can have the size and perform the task of a decentralized edge storage.

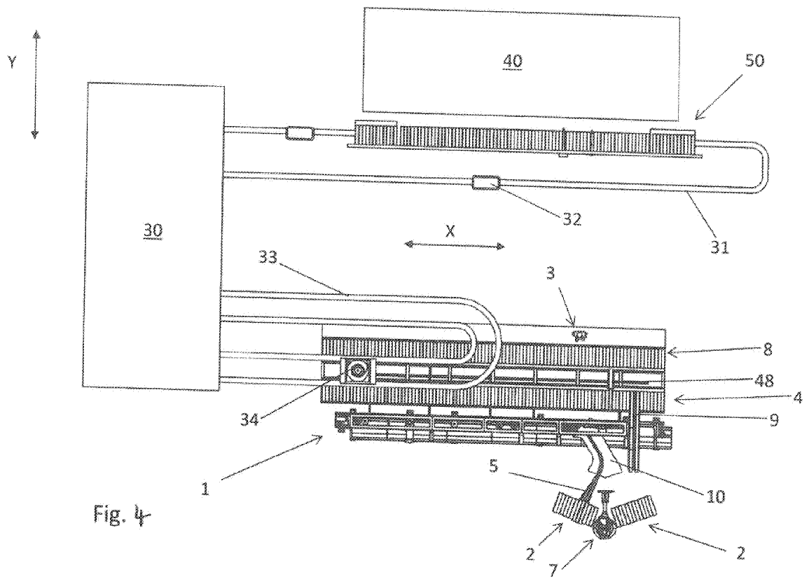

FIG. 4 schematically shows a further embodiment of the edge processing system according to the invention from a top view. A system as described with respect to FIG. 3 is shown in the lower right part of FIG. 4. In this embodiment, the secondary cassette reserve 4, 8 is connected to the central edge storage 30 by means of a transport device 33. The transport device 33 is provided with a cassette transport device 34 which conveys cassettes 6 from the central edge storage 30 to the secondary cassette reserve 4, 8 and/or returns cassettes 6 from the secondary cassette reserve 4, 8 back to the central edge storage 30. The only remaining task of the operator 3 is to monitor the functionality of the components of the edge processing system. A further transport device 31 with a corresponding cassette transport device 32 is shown schematically. It supplies or disposes of a further secondary cassette reserve 50. The secondary cassette reserve 50 supplies a further edge processing machine 40 with a corresponding primary cassette reserve as described above. The central edge storage 30 can also supply more than two edge processing machines 1, 40.

It is furthermore possible to arrange the secondary cassette reserve 4, 8, 50 differently from the edge processing machines 1, 40. It is thus entirely possible to arrange the secondary cassette reserve 4, 8, 50 transversely to the orientation shown. This would make it possible, for example, to supply more than one edge processing machine 1, 40 from a secondary cassette reserve 4, 8, 50.

1. An processing system having at least one edge processing machine (1, 40) to which an edge magazine (10) is attached and at least one primary cassette reserve (2) arranged in the spatial vicinity to the edge magazine (10) of the at least one edge processing machine (1, 40), which has a plurality of receptacle slots (21, 22), in which at least one cassette (6) can be or are received, each containing an edge band (5),
wherein
the edge processing system further comprises at least one secondary cassette reserve (4, 8, 50) different from the at least one primary cassette reserve (2), which is arranged spatially separate from the at least one primary cassette reserve (2).

2. The edge processing system according to claim 1,
further comprising
at least one automated manipulation device (7).

3. The edge processing system according to claim claim 2,
wherein
the at least one automated manipulation device (7) is designed to:
i) transfer the at least one cassette (6) from the at least one primary cassette reserve to the at least one secondary cassette reserve (4, 8, 50) and/or from the at least one secondary cassette reserve (4, 8, 50) to the at least one primary cassette reserve; and/or
ii) supply an edge band (5), which is in the at least one cassette (6) located in the at least one primary cassette reserve (2) at a receiving location (21, 22), to the edge magazine (10) of the at least one edge processing machine (1, 40) or/and to pull said band out of the edge magazine (10) into the at least one cassette (6); and/or
iii) place the at least one cassette (6) on a cassette transport device (32; 34), which is designed in particular as a cassette transport carriage or remove it from the cassette transport device.

4. The edge processing system according to claim 1,
wherein
the at least one secondary cassette reserve (4, 8, 50) is arranged in at least one position selected from the group consisting of:
on the floor adjacent to the at least one edge processing machine (1, 40);
above the at least one edge processing machine (1, 40); and/or
below the at least one edge processing machine (1, 40); and/or
within the at least one edge processing machine (1, 40);
placed as an edge storage away from the at least one edge processing machine (1, 40).

5. The edge processing system according to claim 1,
wherein
the at least one secondary cassette reserve (4, 8, 50) comprises a reserve control device (48) which is designed to
i) remove the at least one cassette (6) in the at least one secondary cassette reserve (4, 8, 50) from a storage space (41, 42, 81, 82) thereof; and/or
ii) deposit the at least one cassette (6) in the at least one secondary cassette reserve (4, 8, 50) in the storage space (41, 42, 81, 82) thereof; and/or
iii) transfer the at least one cassette (6) to a supply or return device (9) and/or to remove it therefrom;
and/or the at least one secondary cassette reserve (4, 8, 50) can be loaded directly from a transport device (32; 34).

6. The edge processing system according to claim 1,
wherein
the at least one secondary cassette reserve (4, 8, 50) has a supply or return device (9) by means of which the at least one cassette (6) transferred from the at least one primary cassette reserve (2) can be received by the at least one secondary cassette reserve (4, 8, 50) and/or the at least one cassette (6) intended for transfer from the at least one secondary cassette reserve (4, 8, 50) to the at least one primary cassette reserve (2).

7. (canceled)

8. The edge processing system according to claim 6,
wherein
the supply or return device (9) comprises a buffer for the temporary storage of the at least one (6) outside the at least one primary edge reserve (2) and the at least one secondary edge reserve (4, 8, 50), or that it is connected to the at least one primary edge reserve (2) and the at least one secondary edge reserve (4, 8, 50).

9. The edge processing system according to claim 1,
further comprising
a central edge storage (30) which is logistically connected to the at least one secondary cassette reserve (4, 8, 50), preferably to two of the at least one secondary cassette reserve (4, 8, 50), and/or to the at least one primary cassette reserve (2) via transport devices (31, 33).

10. The edge processing system according to claim 9,
wherein
the transport devices (31, 33) comprise transport means (32, 34) which are designed to transport the at least one cassette (6) in the central edge storage (30) from the central edge storage (30) to the at least one secondary cassette reserve (4, 8, 50) and/or the at least one cassette (6) from the at least one secondary cassette reserve (4, 8, 50) and/or the at least one primary cassette reserve (2) to the central edge storage (30).

11. The edge processing system according to claim 1,
wherein
the at least one primary cassette reserve (2) and/or the at least one secondary cassette reserve (4, 8, 50) and/or the central edge storage (30) and/or at least one automated manipulation device (7) are designed to receive and/or process and/or handle edge band rolls without the at least one cassette (6).

12. The edge processing system according to claim 2,
wherein
the at least one secondary cassette reserve (4, 8, 50) comprises a reserve control device (48) which is designed to
i) remove the at least one cassette (6) in the at least one secondary cassette reserve (4, 8, 50) from a storage space (41, 42, 81, 82) thereof; and/or
ii) deposit the at least one cassette (6) in the at least one secondary cassette reserve (4, 8, 50) in the storage space (41, 42, 81, 82) thereof; and/or
iii) transfer the at least one cassette (6) to a supply or return device (9) and/or to remove it therefrom;
and/or the at least one secondary cassette reserve (4, 8, 50) can be loaded directly from a transport device (32; 34).

13. The edge processing system according to claim 12,
wherein
the at least one automated manipulation device (7) is designed to load the at least one cassette (6) directly into the reserve control device (48) of the at least one secondary cassette reserve (4, 8, 50) and that the at least one cassette (6) can be removed directly from the at least one secondary cassette reserve (4, 8, 50).
